(19) United States
(12) Patent Application Publication
(10) Pub. No.: US 2019/0205388 A1
(43) Pub. Date: Jul. 4, 2019

(54) GENERATION METHOD, INFORMATION PROCESSING APPARATUS, AND STORAGE MEDIUM

(71) Applicant: FUJITSU LIMITED, Kawasaki-shi (JP)

(72) Inventor: Mitsugu Otaki, Kawasaki (JP)

(73) Assignee: FUJITSU LIMITED, Kawasaki-shi (JP)

(21) Appl. No.: 16/213,219

(22) Filed: Dec. 7, 2018

(30) Foreign Application Priority Data
Dec. 28, 2017 (JP) 2017-254324

(51) Int. Cl. G06F 17/27

(52) U.S. Cl. CPC G06F 17/2785; G06F 17/2765

(57) ABSTRACT

A non-transitory computer-readable storage medium storing a program that causes a computer to execute a process, the process includes obtaining document data; when a plurality of documents are included in the obtained document data, based on an occurrence frequency of each word included in one of the plurality of documents among the plurality of documents and an occurrence frequency of the each word in another document included in the plurality of documents, identifying a word from the each word; and generating a question sentence regarding the identified word.

### CROSS-REFERENCE TO RELATED APPLICATION

This application is based upon and claims the benefit of priority of the prior Japanese Patent Application No. 2017-254324, filed on Dec. 28, 2017, the entire contents of which are incorporated herein by reference.

### FIELD

The embodiments discussed herein are related to a generation method, an information processing apparatus, and a storage medium.

### BACKGROUND

In a work in which a replier replies to a question of a questioner, techniques are known that enable the replier to lead the questioner to a suitable reply efficiently with a little expertise and effort. For example, a document search apparatus is known that performs morphological analysis on an input search condition to extract a word and that generates an initial conditional search expression from a word stem of the word and the conditional search expression. The apparatus generates a narrowing-down conditional search expression from the variation form of the word and the conditional search expression by using a morphological analysis result of the word extracted from the conditional search expression and conducts a primary search on a document DB for the initial conditional search expression to generate an intermediate result. The apparatus applies the narrowing-down conditional search expression on the intermediate result document to conduct a full text search.

An apparatus is also known that conducts a full text search based on a query specified by a user, extracts an effective word from each document obtained as a result of the search, determines the reliability of the search result document by using the extracted effective word, and presents a search result based on the reliability. Further, a system is also known that searches for a similar image corresponding to search reference image data by a keyword search using metadata. In the system, a plurality of single report structured data stored in a structured DB in a medical examination information DB and text information included in a medical image interpretation report described in the detailed information on the image data are attached to the image data as metadata for searching. In the system, when a medical image interpretation doctor who is a user specifies image data to be interpreted while the system is reading the image as search reference image data to be a search reference, text information attached to the search reference image data is determined to be a keyword. As the related art, for example, Japanese Laid-open Patent Publication No. 2005-4606, Japanese Laid-open Patent Publication No. 2002-366582, Japanese Laid-open Patent Publication No. 2008-52544, and the like are disclosed.

However, if the skill level of a replier in the above-described techniques is low, it is difficult to lead a questioner to a suitable reply. For example, in the case where a reply to a question is searched for by using a database that stores a plurality of sentences, such as a FAQ, and the like, the replier sometimes presents an additional question to the questioner in order to identify a best-suited reply from a plurality of candidate replies. In this case, an additional question is not generated by the above-described techniques. Accordingly, the contents of the additional question depend on the skill level of the replier. If the skill level of the replier is low, it is sometimes not possible to identify a best-suited reply because an additional question is not suitable. It is desirable to generate a precise question.

### SUMMARY

According to an aspect of the embodiments, a non-transitory computer-readable storage medium storing a program that causes a computer to execute a process, the process includes obtaining document data; when a plurality of documents are included in the obtained document data, based on an occurrence frequency of each word included in one of the plurality of documents among the plurality of documents and an occurrence frequency of the each word in another document included in the plurality of documents, identifying a word from the each word; and generating a question sentence regarding the identified word.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an overall configuration according to a first embodiment;

FIG. 2 is a diagram illustrating an example of generation processing according to the first embodiment;

FIG. 3 is a diagram illustrating an example of a generation apparatus according to the first embodiment;

FIG. 4 is a diagram illustrating an example of a case DB according to the first embodiment;

FIG. 5 is a diagram illustrating an example of a concept DB according to the first embodiment;

FIG. 6 is a flowchart illustrating an example of generation processing according to the first embodiment;

FIG. 7 is a diagram illustrating an example of a generation apparatus according to a second embodiment;

FIG. 8 is a diagram illustrating an example of a semantic network DB according to the second embodiment;

FIG. 9 is a diagram illustrating an example of generation processing according to the second embodiment;

FIG. 10 is a flowchart illustrating an example of generation processing according to the second embodiment; and

FIG. 11 is a diagram illustrating an example of a hardware configuration.

### DESCRIPTION OF EMBODIMENTS

Hereinafter detailed descriptions will be given of a generation program, a generation method, and an information processing apparatus according to embodiments of the present disclosure with reference to the drawings. The embodiments will not limit the disclosure. Each embodiment described below may be combined within the range that does not cause inconsistencies.

### First Embodiment

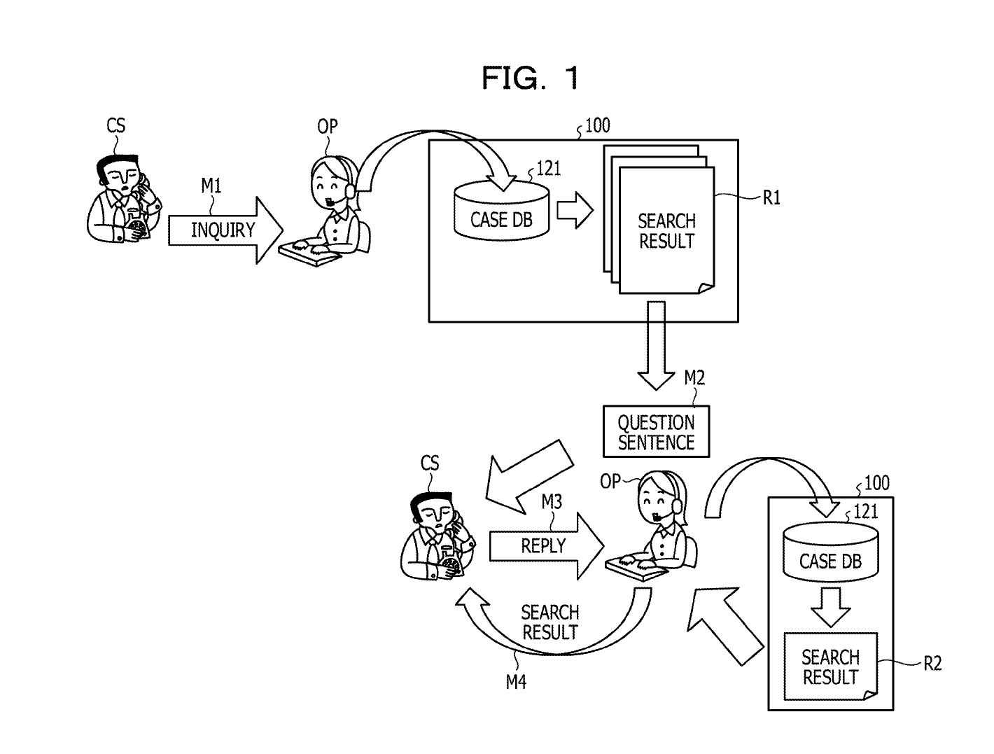

First, a description will be given of a processing flow according to the present embodiment with reference to FIG. 1. FIG. 1 is a diagram illustrating an example of an overall configuration according to a first embodiment. As illustrated in FIG. 1, a generation apparatus 100 according to the present embodiment described below is operated, for example, by an operator OP who receives an inquiry from a customer CS. The generation apparatus 100 is an example of an information processing apparatus. The customer CS is an example of a user.

First, when the operator OP receives an inquiry M1 from the customer CS, the operator OP accesses the generation apparatus 100. The generation apparatus 100 extracts a search result R1 including a plurality of cases corresponding to the inquiry M1 from various cases stored in a case DB 121 described later. The generation apparatus 100 generates a question sentence M2 by using the search result R1 and outputs the question sentence M2 to the operator OP.

The operator OP presents the question sentence M2 to the customer CS and receives a reply M3 from the customer CS. The operator OP further accesses the generation apparatus 100 by using the reply M3.

The generation apparatus 100 extracts a search result R2, which is a single case corresponding to the reply M3, from the case DB 121. The operator OP presents a reply M4 including the search result R2 to the customer CS.

In common techniques, the question sentence M2 for narrowing down a plurality of cases included in the search result R1 into a single case is created by the operator OP. In this case, the contents of the question sentence M2 depend on the skill level of the operator OP. If the skill level of the operator OP is low, the contents of the question sentence M2 are not correct, and thus it is sometimes difficult to provide information demanded for identifying the search result R2 from the customer CS.

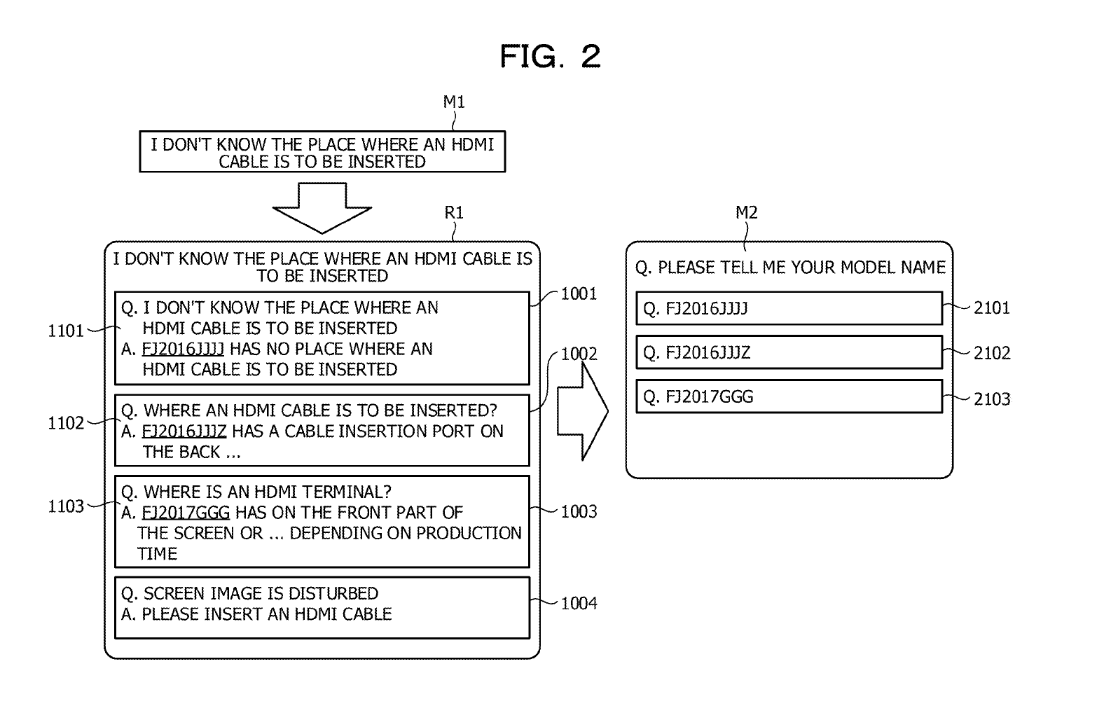

On the other hand, when the generation apparatus 100 according to the present embodiment generates the question sentence M2, the generation apparatus 100 identifies any one of the words by using the words included in a plurality of cases included in the search result R1. FIG. 2 is a diagram illustrating an example of generation processing according to the first embodiment. For example, the generation apparatus 100 receives from the customer CS input of an inquiry M1 having the content of “I don't know the place where an HDMI (registered trademark) cable is to be inserted”. The generation apparatus 100 refers to the case DB 121 by using the inquiry M1 and extracts a search result R1 by using a plurality of cases 1001 to 1004.

Next, the generation apparatus 100 extracts words 1101 to 1103 included in the cases 1001 to 1003 included in the search result R1. As illustrated in FIG. 2, for example, the word 1101 is a word indicating a model name, “FJ20163JJJ”. In the same manner, for example, the word 1102 is a word indicating a model name, and “FJ2016JJJZ”, the word 1103 is a word indicating a model name, “FJ2017GGG”. The generation apparatus 100 identifies that the case 1004 does not include a word indicating a model name.

The generation apparatus 100 generates and outputs a sentence, “Q. Please tell me your model name” as a question sentence M2 for checking the “model name”, which is a common “concept” among the extracted words 1101 to 1103. At that time, the generation apparatus 100 simultaneously generates choices 2101 to 2103 corresponding to the question sentence M2.

For example, if a reply M3 to the question sentence M2, received from the customer CS, is “FJ20163JJJ”, the generation apparatus 100 outputs the case 1001 including the word 1101 as the search result R2.

In this manner, the generation apparatus 100 according to the present embodiment identifies any one of the words based on the occurrence frequencies of the words included in a plurality of documents that are similar to each other and generates a question sentence of the semantic network of the identified word. Thereby, it is possible to generate a suitable question without depending on the skill level.

[Functional Blocks]

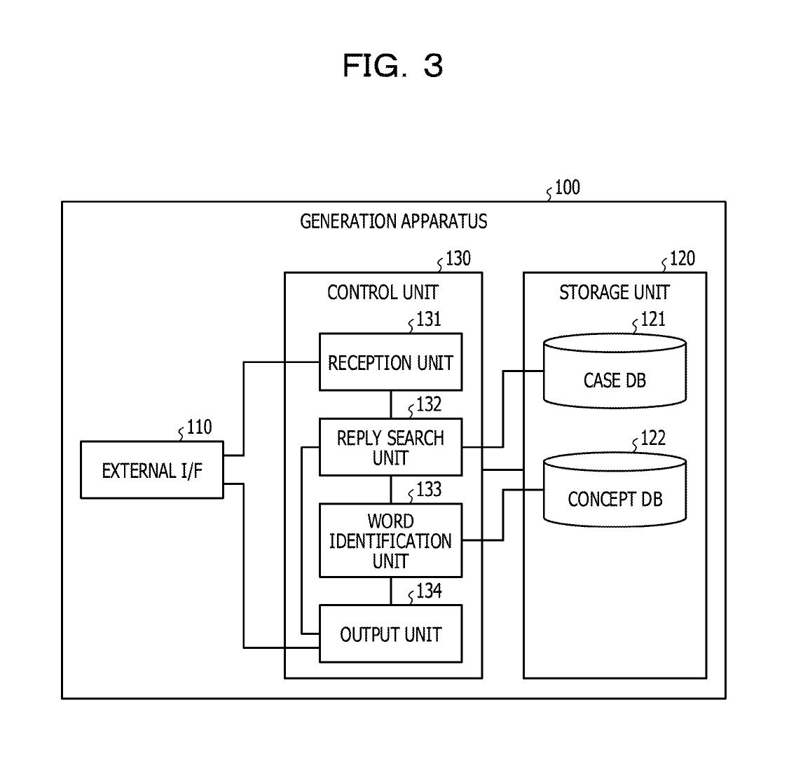

Next, a description will be given of an example of the generation apparatus 100 according to the present embodiment with reference to FIG. 3. FIG. 3 is a diagram illustrating an example of the generation apparatus according to the first embodiment. As illustrated in FIG. 3, the generation apparatus 100 according to the present embodiment includes an external I/F 110, a storage unit 120, and a control unit 130.

The external I/F 110 controls communication with the other computers, such as a terminal (not illustrated in the figure) of an operator OP, or the like and a user, such as an operator OP, or the like regardless of being wired or wireless. The external I/F 110 is a communication interface, for example, a network interface card (NIC), or the like. However, the external I/F 110 is not limited to this and may be a user interface of an input device, a display device, or the like.

The storage unit 120 is an example of a storage device that stores a program and data and is, for example, a memory, a processor, or the like. The storage unit 120 includes the case DB 121 and a concept DB 122. Hereinafter a database is sometimes referred to as a “DB”.

The case DB 121 stores the contents of an inquiry and the contents of a reply thereto in association with each other. The information stored in the case DB 121 is, for example, the contents of an inquiry received in the past and the contents of a reply thereto and is input by the operator OP. The information stored in the case DB 121 may be obtained, for example, from an external response history log, or the like. The case DB 121 stores the information, for example, as one record per case. A case is an example of a document. The case DB 121 is an example of a reply database.

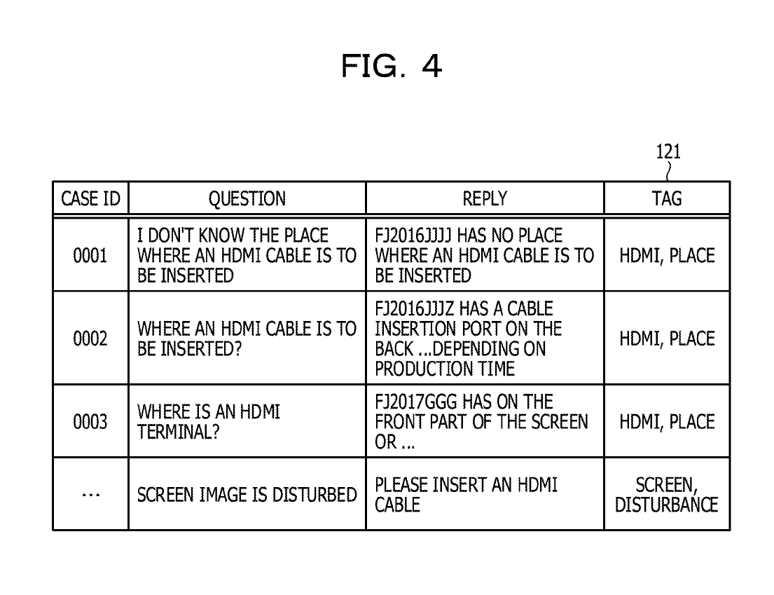

FIG. 4 is a diagram illustrating an example of a case DB according to the first embodiment. As illustrated in FIG. 4, the case DB 121 stores items, for example, “question”, “reply”, and “tag” in association with “case identifier (ID)”. In FIG. 4, the item “case ID” is an identifier that uniquely identifies a combination of a question and a reply. The items “question” and “reply” store the contents of an inquiry by a user received in the past and the contents of a reply thereto, respectively. The item “tag” stores a keyword, and the like corresponding to the contents of a question and a reply. The contents of an inquiry are examples of “question contents”, and the contents of a reply are examples of “reply contents”.

For example, in FIG. 4, a case having the case ID “0001” indicates that the reply “F320163333 has no place where an HDMI cable is to be inserted” is made in response to the inquiry, “I don't know the place where an HDMI cable is to be inserted”. The tags that are given to the case of the case ID “0001” are “HDMI” and “place”.

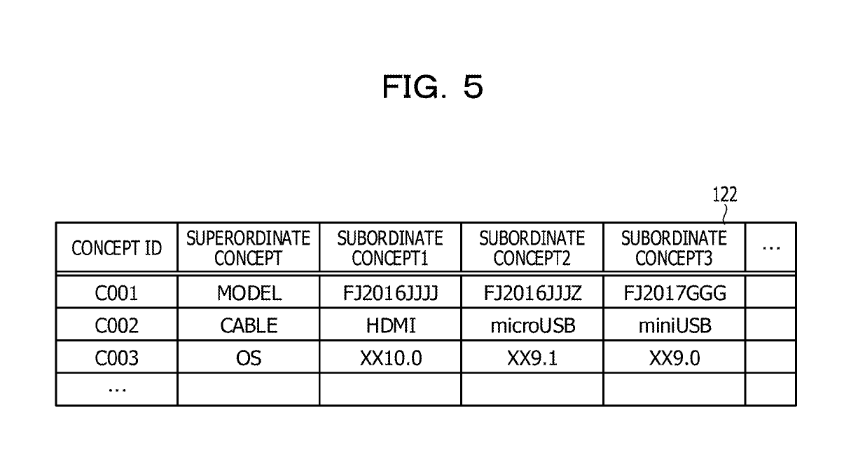

Next, the concept DB 122 stores a word and a superordinate concept corresponding thereto in association with each other. FIG. 5 is a diagram illustrating an example of a concept DB according to the first embodiment. As illustrated in FIG. 5, the concept DB 122 stores, for example, “superordinate concept” and “subordinate concept 1” to “subordinate concept 3” in association with “concept ID”. The information to be stored in the concept DB 122 is, for example, information that has been obtained from an external synonym database, a model database of a manufacturer, and the like. The external synonym database stores synonyms that are identified by publicly known techniques, for example, WordNet, Word2Vec, or the like. The concept DB 122 stores, for example, information for each concept as one record.

In FIG. 5, the item “concept ID” is an identifier that uniquely identifies a combination of a superordinate concept and a subordinate concept. The item “superordinate concept” stores a superordinate concept that includes individual words indicated by the items “subordinate concept 1” to “subordinate concept 3”. The items “subordinate concept 1” to “subordinate concept 3” store individual words that are subordinate to a common superordinate concept.

For example, in FIG. 5, a case having the concept ID “C001” stores subordinate concepts “FJ2016JJJJ”, “FJ2016JJJZ”, and “FJ2017GGG” so as to be subordinate to a superordinate concept “model”.

In FIG. 5, an example having three subordinate concepts is illustrated. However, the number of subordinate concepts is not limited to this. Alternatively, a word stored in a superordinate concept may further be stored as a subordinate concept of another word. Alternatively, one word may be subordinate to a word having a plurality of superordinate concepts.

Referring back to FIG. 3, the control unit 130 is a processing unit that controls the entire generation apparatus 100 and is, for example, a processor, or the like. The control unit 130 includes a reception unit 131, a reply search unit 132, a word identification unit 133, and an output unit 134. The reception unit 131, the reply search unit 132, the word identification unit 133, and the output unit 134 are examples of an electronic circuit of a processor or examples of processes executed by a processor.

The reception unit 131 receives an inquiry from a customer CS. When the reception unit 131 receives an inquiry, for example, from a terminal (not illustrated in the figure) of the customer CS via the external I/F 110, the reception unit 131 outputs the information on the received inquiry to the reply search unit 132.

The reception unit 131 further receives a reply to the generated question sentence via the external I/F 110. When the reception unit 131 receives, for example, that the customer CS has selected any one of the choices corresponding to the generated question sentence, the reception unit 131 outputs information on the selected choice to the reply search unit 132.

The reply search unit 132 refers to the case DB 121 and searches for a case corresponding to an inquiry or a reply. When the reply search unit 132 receives input of information regarding the inquiry from the reception unit 131, the reply search unit 132 refers to the case DB 121 and searches for a case corresponding to the inquiry. At this time, the reply search unit 132 searches for at least any one of the items “question”, “reply”, and “tag” that are stored in the case DB 121. The reply search unit 132 is an example of the acquisition unit.

When the reply search unit 132 receives input of a reply to the question sentence from the reception unit 131, the reply search unit 132 refers to the case DB 121 and searches for a case corresponding to the reply.

If there is only one candidate for the searched case as a result of the reference to the case DB 121, the reply search unit 132 outputs the candidate for the case to the output unit 134. On the other hand, if there are two or more candidates for the searched case, the reply search unit 132 outputs the candidates for the case to the word identification unit 133. If there are no candidates for the case, the reply search unit 132 may output the information indicating that there are no corresponding cases to the word identification unit 133 or the output unit 134.

The word identification unit 133 identifies a word included in a question sentence presented to the customer CS by using a word included in a candidate of the case. When the word identification unit 133 obtains a candidate of the case from the reply search unit 132, the word identification unit 133 identifies candidates of a plurality of cases having a similarity between the cases that satisfy a predetermined criterion out of the candidates of the plurality of cases. It is possible to identify the similarity between the cases by using a publicly known method, for example, Doc2Vec, or the like. The word identification unit 133 is an example of the identification unit.

Next, the word identification unit 133 extracts a word that is representative of a feature of each case for each candidate of a plurality of cases having the identified similarity that satisfies a predetermined criterion. A word that features the case is, for example, a word that occurs only in the case among the identified plurality of candidates for the case. It is possible to identify a word that features the case by using a publicly known method, for example, TF-IDF, or the like. Hereinafter a word that features the case is sometimes referred to as a “feature word”.

Next, the word identification unit 133 refers to the concept DB 122 and extracts a superordinate concept corresponding to the individual extracted feature words. For example, if the individual feature words are “F32016JJJJ”, “F32016JJJZ”, and “F32017GGG”, the word identification unit 133 extracts a “model” as a corresponding superordinate concept. The word identification unit 133 outputs a word indicating the extracted superordinate concept to the output unit 134. Hereinafter a word indicating a superordinate concept is sometimes referred to as a “superordinate word”.

When the word identification unit 133 receives a response to the generated question sentence and further receives output of the candidates of a plurality of cases from the reply search unit 132, the word identification unit 133 repeats processing for identifying a word included in a new question sentence.

When the word identification unit 133 receives, for example, output of the information indicating that there are no corresponding cases from the reply search unit 132, the word identification unit 133 may extract, for example, the case that has not been extracted because the similarity between the cases failed to satisfy a predetermined criterion in the processing for generating a previous question sentence and generate a question sentence.

The output unit 134 generates a question sentence by using the identified superordinate word and outputs the question sentence. The output unit 134 is an example of the generation unit.

When the output unit 134 receives, for example, the words, “model name”, from the word identification unit 133, the output unit 134 generates a question sentence such as “Q. Please tell me your model name” as illustrated in FIG. 2. The output unit 134 outputs the question sentence, for example, to the terminal of the operator OP, or the like via the external I/F 110. In the case where no candidates for the case have been found by the search, when the output unit 134 receives output of the information indicating that there are no cases from the reply search unit 132 or the word identification unit 133, the output unit 134 may output the information indicating the search result.

For example, if the superordinate word is “model”, the output unit 134 converts a sentence by using a superordinate word into an expression close to a natural sentence and outputs the natural sentence as “Please tell me your model name” as illustrated in FIG. 2.

[Processing Flow]

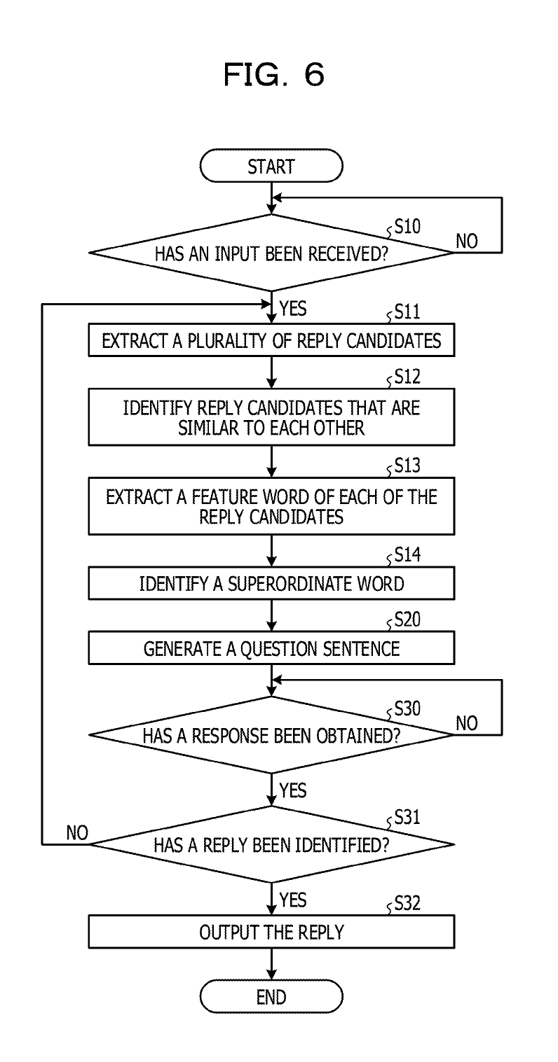

Next, a description will be given of the processing according to the present embodiment with reference to FIG. 6. FIG. 6 is a flowchart illustrating generation processing according to the first embodiment. As illustrated in FIG. 6, the reception unit 131 of the generation apparatus 100 waits, for example, until the reception unit 131 receives input of inquiry contents via the external I/F 110 (S10: No).

If the reception unit 131 determines to have received input (S10: Yes), the reception unit 131 outputs the contents of the input inquiry to the reply search unit 132. The reply search unit 132 searches the case DB 121 by using the contents of the inquiry, extracts a plurality of reply candidates, and outputs the reply candidates to the word identification unit 133 (S11).

The word identification unit 133 identifies reply candidates that are similar to each other from the extracted plurality of reply candidates (S12). Next, the word identification unit 133 extracts a feature word of each of the identified reply candidates (S13). Next, the word identification unit 133 refers to the concept DB 122, identifies a superordinate word of each feature word, and outputs the superordinate word to the output unit 134 (S14).

The output unit 134 generates a question sentence by using the identified superordinate word and, for example, outputs the question sentence via the external I/F 110 (S20). After that, the output unit 134 waits to obtain a response (S30: No).

If the reception unit 131 determines that a response has been obtained (S30: Yes), the reception unit 131 outputs the response to the reply search unit 132. The reply search unit 132 searches the case DB 121 and determines whether or not a reply from the reply candidates has been identified (S31).

If the reply search unit 132 determines that a reply has not been identified (S31: No), the processing returns to S11 and repeats the processing. On the other hand, if the reply search unit 132 determines that a reply has been identified (S31: Yes), the reply search unit 132 outputs the identified reply to the output unit 134. The output unit 134 outputs the identified reply (S32) and the processing is terminated.

[Advantages]

As described above, the generation apparatus 100 according to the present embodiment obtains document data, and if the obtained document data include a plurality of documents, the generation apparatus 100 identifies any of the words out of the individual words based on the occurrence frequency of each of the words included in any one of the documents in the any one of the documents out of a plurality of documents and identifies the occurrence frequency of each word of the words included in the plurality of documents in the other documents. The generation apparatus 100 according to the present embodiment generates a question sentence regarding the identified word. Thereby, it is possible to generate an appropriate question.

The generation apparatus 100 may identify a plurality of documents having similarity between the documents that satisfy a criterion out of the plurality of documents included in the obtained document data and select any one of the documents and the other documents from the identified plurality of documents. Thereby, it is possible to narrow down the candidates for a reply and generate a question to further narrow down the reply.

The generation apparatus 100 may identify a word that features each document in a plurality of documents having similarity between the documents that satisfies a criterion. The generation apparatus 100 identifies, for example, a word that appears only in any one of the documents as a word that features each document. The generation apparatus 100 may generate a question sentence by using a superordinate concept common to the word that features each document of the identified documents. Thereby, it is possible to generate as a choice a question in accordance with the contents of each document.

Further, the generation apparatus 100 may obtain document data including a plurality of documents including question contents and reply contents and identify any one of the words based on the occurrence frequency of each word in the question contents included in a plurality of documents and the occurrence frequency of each word in the reply contents. Thereby, it is possible to generate a question for searching for a reply that matches an inquiry of a user by using the database, such as a past inquiry history, or the like.

The generation apparatus 100 receives input of an inquiry from a user and extracts document data including a plurality of documents, which are candidates for response documents to inquiries from users, from the reply database. The generation apparatus 100 may generate a question sentence for identifying a response document from the extracted plurality of documents. Further, the generation apparatus 100 may receive from the user a reply to the generated question sentence and further obtain document data including a plurality of documents, which are candidates for a response document to the received reply. Thereby, it is possible to generate a question for searching for a reply that meets the inquiry from the user in an interactive mode with the user.

### Second Embodiment

Incidentally, when the generation apparatus 100 generates a question sentence, if the contents to be checked by a customer CS is a “model name”, or the like, a question of “What” ought to be inquired just like “What is your model name?”. However, for example, there are cases where the contents to be checked include many things, for example, in the case of “the state of a screen”, whether or not the screen is displayed, what color is the screen?, whether the display speed is normal or delayed, and the like. In such a case, if the contents of a question is not adapted to the contents to be checked, it is difficult to identify a best suited reply.

Thus, in the present embodiment, a description will be given of a configuration in which the generation apparatus changes an expression of the question contents in accordance with the contents to be checked by a customer CS.

[Functional Block]

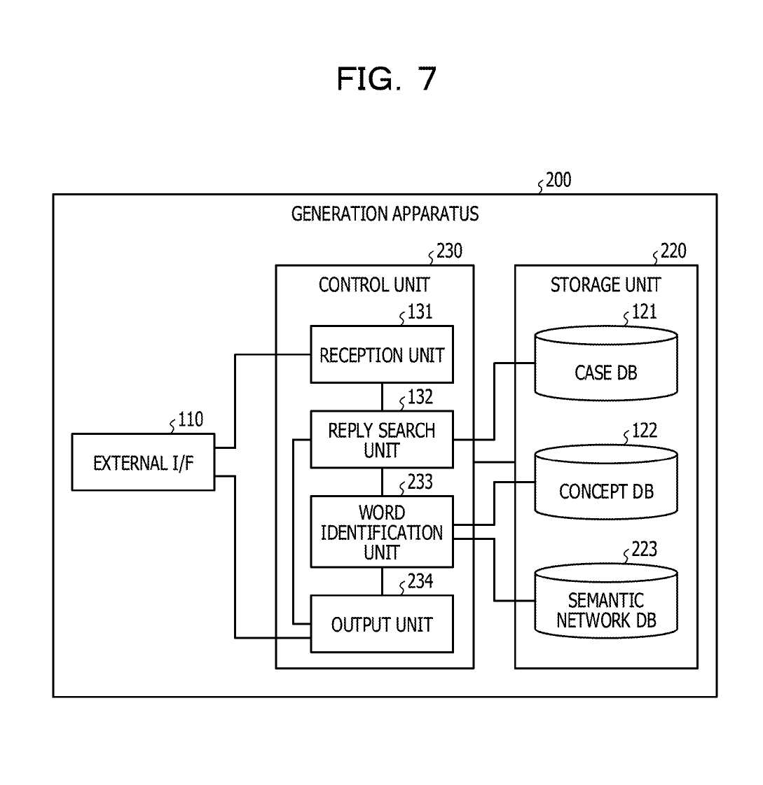

FIG. 7 is a diagram illustrating an example of a generation apparatus according to a second embodiment. In the following embodiment, a same sign is given to a same part as the part illustrated in the figures described above, and overlapping descriptions will be omitted. A generation apparatus 200 according to the present embodiment includes an external I/F 110, a storage unit 220, and a control unit 230.

The storage unit 220 is an example of a storage device that stores a program and data. The storage unit 220 is, for example, a memory, a processor, or the like. The storage unit 220 further includes a semantic network DB 223 in addition to the case DB 121 and the concept DB 122.

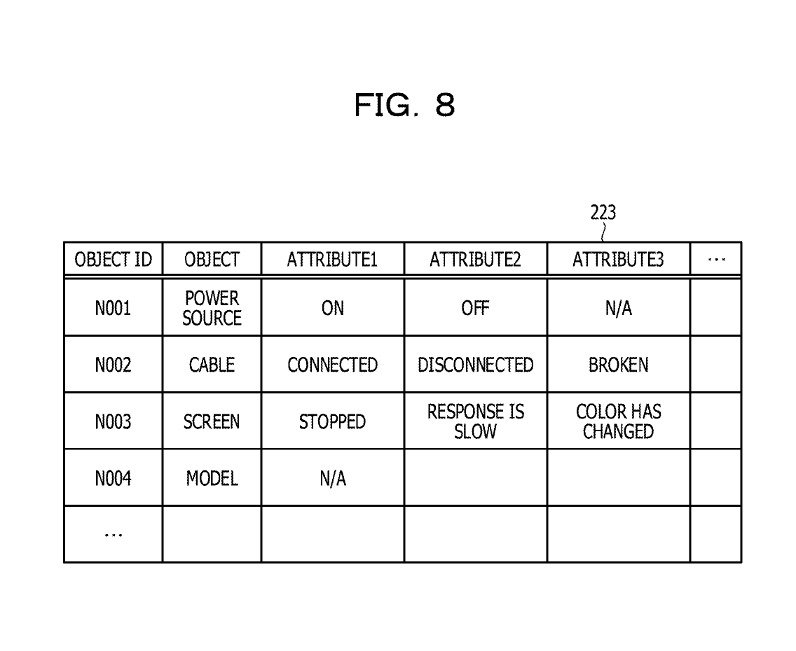

The semantic network DB 223 stores a word to be an object and corresponding state and operation, and the like in association with each other. FIG. 8 is a diagram illustrating an example of a semantic network DB according to the second embodiment. As illustrated in FIG. 8, the semantic network DB 223 stores items “object” and “attribute 1” to “attribute 3” in association with “object ID”. The information stored in the semantic network DB 223 is, for example, the information obtained the external synonym database, or the like. The semantic network DB 223 stores, for example, information for each object as one record.

In FIG. 8, the item “object ID” is an identifier that uniquely identifies a combination of an object and attributes. In the item “object”, an object to be checked, for example, a part of a computer, a device, or the like is stored. In the items “attribute 1” to “attribute 3”, an attribute including operation related to the object, the possible states of the object, and the like are stored.

For example, in FIG. 8, as for a case having the object ID “N001”, corresponding attributes of “on” and “disconnected” are stored for the object “power source”. In FIG. 5, the case of including three subordinate concepts is illustrated. However, the number of subordinate concepts is not limited to this. For example, the number of subordinate concepts may be only two as in “N001” or four or more. For example, as illustrated in the object ID “N004”, in the case where no attributes are defined for an object and only an object ought to be identified, or the like, “N/A” is stored in the attribute 1.

Referring back to FIG. 7, the control unit 230 is a processing unit that controls the entire generation apparatus 200 and is, for example, a processor, or the like. The control unit 230 includes a reception unit 131, a reply search unit 132, a word identification unit 233, and an output unit 234. The word identification unit 233 and the output unit 234 are examples of electronic circuits of the processor or examples of processes executed by the processor.

The word identification unit 233 further identifies an attribute corresponding to the word in addition to a superordinate word identified from a word included in the candidates for the case and outputs the attribute to the output unit 234. The word identification unit 233 refers to the semantic network DB 223 based on each feature word and the superordinate word and identifies an attribute corresponding to the superordinate word.

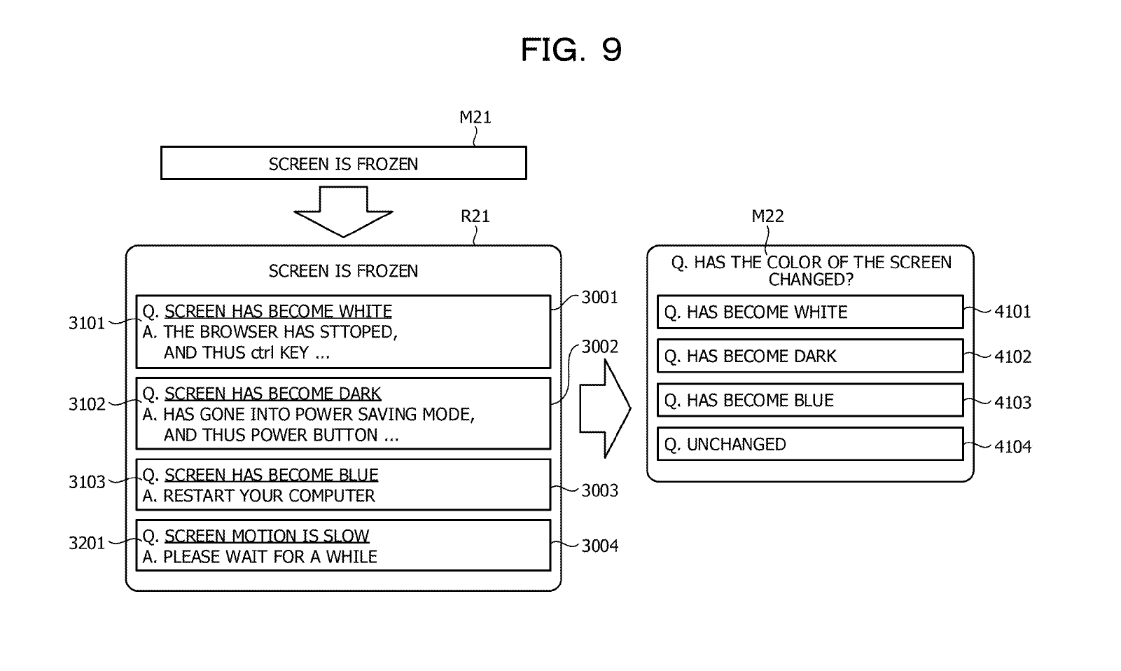

A description will be given of the processing performed by the word identification unit 233 and the output unit 234 with reference to FIG. 9. FIG. 9 is a diagram illustrating an example of the generation processing according to the second embodiment. As illustrated in FIG. 9, for example, when a question M21, “screen is frozen” is received from a customer CS, the reply search unit 132 refers to the case DB 121 by using the question M21 and extracts a search result R21 including a plurality of cases 3001 to 3004.

In this case, the word identification unit 233 extracts a word “screen”, which is commonly included in the cases 3001 to 3004 included in the search result R1 as an object. The word identification unit 233 identifies, for example, a part 3101 indicating that the screen has become “white” in the case 3001. In the same manner, the word identification unit 233 identifies a part 3102 indicating that the screen has become “dark” in the case 3002 and identifies a part 3103 indicating that the screen has become “blue” in the case 3003. The word identification unit 233 identifies a part 3201 indicating that the “screen motion is slow” in the case 3004.

The word identification unit 233 refers to the semantic network DB 223 and identifies that the attribute corresponding to the identified parts 3101 to 3103 for the object “screen” is “color has changed”. In the same manner, the word identification unit 233 refers to the semantic network DB 223 and identifies that the attribute corresponding to the identified part 3201 is “response is slow” for the object “screen”.

In this case, the word identification unit 233 outputs, for example, the attribute “color has changed” having a large number of corresponding cases out of the two identified attributes to the output unit 234.

The output unit 234 generates a question sentence by using the identified superordinate word and the attributes and outputs a question sentence. For example, if the output unit 234 receives the superordinate word of “screen” and the attribute of “color has changed” from the word identification unit 233, the output unit 234 generates a sentence, “Q. Has the color of the screen changed?” as a question sentence M22 as illustrated in FIG. 9. At that time, the output unit 234 generates choices 4101 to 4104 corresponding to the question sentence M22 as well.

For example, if the superordinate word is “screen” and the attribute is “color has changed”, the output unit 234 converts a sentence by using the attribute and the superordinate word into an expression close to a natural sentence just like “Has the color of the screen changed?” as illustrated in FIG. 9 and outputs the sentence.

If a reply to the question sentence M22, received from the customer CS, is any one of the choices 4101 to 4103, the reply search unit 132 identifies any one of the cases 3001 to 3003 corresponding to any one of the choices 4101 to 4103 as a reply. On the other hand, if the reply received from the customer CS is a choice 4104, the reply search unit 132 identifies a case 3004 corresponding to the choice 4104 as a reply.

[Processing Flow]

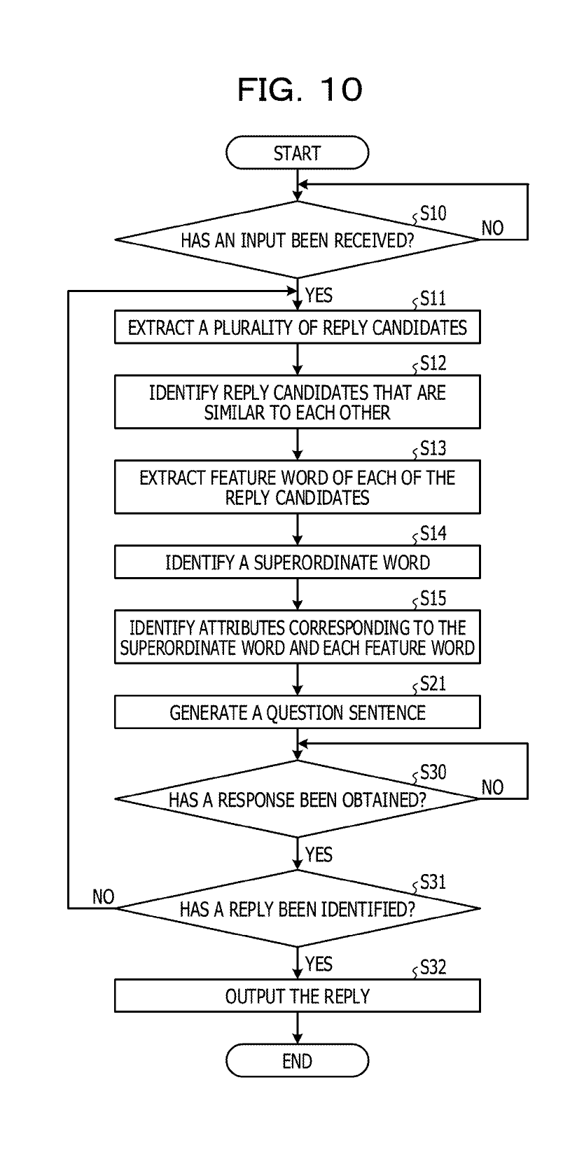

Next, for the processing according to the present embodiment, FIG. 10 is an example of flowchart illustrating the generation processing according to the second embodiment. In the following description, a step given a same sign as the step illustrated in FIG. 6 is the identical step, and thus the detailed description will omitted.

As illustrated in FIG. 10, when the word identification unit 233 of the generation apparatus 200 identifies a superordinate word for each feature word (S14), the word identification unit 233 refers to the semantic network DB 223, identifies attributes corresponding to the identified superordinate word and each feature word, and outputs the attributes to the output unit 234 (S15). The output unit 234 generates a question sentence by using the identified superordinate word and attributes (S21).

[Advantages]

As described above, the generation apparatus 200 according to the present embodiment identifies a word regarding an operation or an attribute extracted based on the semantic network corresponding to a word that features each document and converts the word regarding the operation or the attribute into an interrogative sentence so as to generate a question sentence. Thereby, it is possible to generate a question having an expression adapted to the contents to be checked.

### Third Embodiment

The descriptions have been given of the embodiments of the present disclosure so far, but the present disclosure may be implemented in various different forms in addition to the above-described embodiments. For example, the generation apparatus 100 or 200 may change a question sentence in the case of receiving the same inquiry next in accordance with a reply to a question sentence by the customer CS. For example, as illustrated in FIG. 9, if there are many cases where the choice 4104 corresponding to not the attribute “color has changed”, but the attribute “the response is slow” with reference to the question sentence M22, the generation apparatus 200 may generate a question sentence by using the attribute in the case of receiving the similar inquiry next. Thereby, it is possible to feed back the response result corresponding to the question sentence generated in the past to the generation of the next question sentence and generate a question with high precision.

The information stored in each DB is an example and may have another structure, and for example, the case DB 121 illustrated in FIG. 4 may have a structure not including “tag”. The data structure of each DB is not limited to a table format and may be a tree structure or a network structure.

The case DB 121 may further store a “resolution rate” that indicates the resolved rate of an inquiry by a customer CS in the case where a reply is presented in each case. In this case, if a plurality of superordinate concepts are extracted from a plurality of feature words included in each case that has been output from the reply search unit 132, the word identification unit 133 may identify a superordinate concept of a feature word included in the case having the highest resolution rate. In the same manner, if a plurality of respective attributes are extracted from a plurality of feature words included in each case that has been output from the reply search unit 132, the word identification unit 233 may identify an attribute of a feature word included in the case having the highest resolution rate. In place of a feature word included in the case having the highest resolution rate, the word identification unit 133 or 233 may calculate the sum total of the resolution rate of each case including a feature word corresponding to each superordinate concept or each attribute. Thereby, it is possible to generate a question having a higher resolution rate of an inquiry.

The description has been given of each embodiment by taking, for example, an interactive conversation between a customer CS and an operator OP at a help desk of a computer. However, the embodiments are not limited to this. For example, in the case of applying this technique to a call center regarding how to cook, the generation apparatus 200 may store a “vegetable” as a superordinate word corresponding to a “carrot” and a “cabbage” and store “cut”, “fry”, and the like as attributes. For example, at a call center of a ticket reservation center, the generation apparatus 200 may store attributes, such as “watch”, “play”, and the like as the attributes of a “sport”.

The descriptions have been given of the cases where an operator OP inputs an inquiry by a customer CS into the generation apparatus 100 or 200, and an output question sentence is given to the customer CS again. However, the embodiments are not limited to this. For example, the generation apparatus 100 or 200 may directly receive an inquiry from a customer CS via an operation unit (not illustrated in the figure) and a question sentence may be output via a display unit (not illustrated in the figure).

[System]

In addition, it is possible to change, in any way, information including a processing procedure, a control procedure, a specific name, various kinds of data, and parameters in the above-described documents and the drawings unless otherwise specified.

Each component of each device illustrated in the drawings is functionally conceptual and does not have to be physically configured as illustrated in the drawings. That is to say, a specific mode of distribution and integration of each device is not limited to that illustrated in the drawings. That is to say, it is possible to configure all of or a part of each device by functionally or physically distributing or integrating in any units in accordance with various loads, use states, and the like. For example, the reception unit 131 and the reply search unit 132 illustrated in FIG. 3 may be integrated, or the reception unit 131 and the output unit 134 may be integrated. The word identification unit 233 illustrated in FIG. 7 may be distributed into a processing unit that identifies a superordinate word and a processing unit that identifies an attribute. Further, it is possible to realize all of or a part of each processing function performed by each device by a CPU and a program to be analyzed and executed by the CPU or as hardware by wired logic.

[Hardware Configuration]

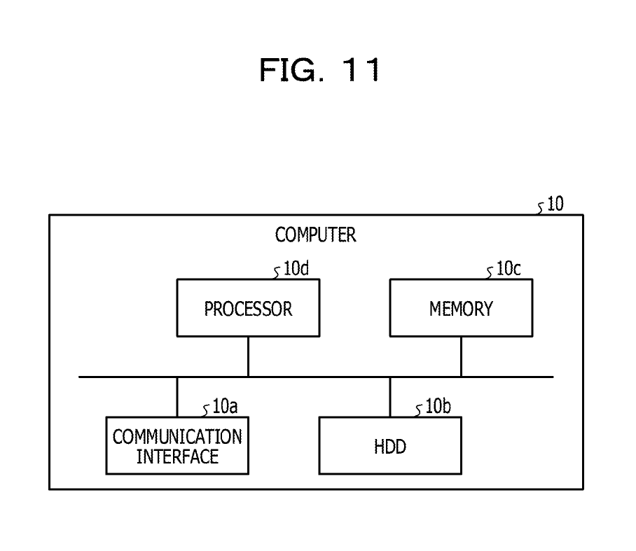

FIG. 11 is a diagram illustrating an example of a hardware configuration. As illustrated in FIG. 11, a computer 10 includes a communication interface 10a, a hard disk drive (HDD) 10b, a memory 10c, and a processor 10d. Hereinafter a description will be given of the generation apparatus 100 according to the first embodiment. It is possible to realize the generation apparatus according to the other embodiments by the same configuration.

The communication interface 10a is a network interface card that controls communication with the other device, or the like. The HDD 10b is an example of a storage device that stores a program, data, and the like.

As an example of the memory 10c, a random access memory (RAM), such as a synchronous dynamic random access memory (SDRAM), or the like, a read only memory (ROM), a flash memory, or the like is given. As an example of a processor 10d, a central processing unit (CPU), a digital signal processor (DSP), a field programmable gate array (FPGA), a programmable logic device (PLD), or the like is given.

The computer 10 operates as an information processing apparatus that performs a learning method by reading a program and executing the program. That is to say, the computer 10 executes the program that performs the same functions as those of the reception unit 131, the reply search unit 132, the word identification unit 133, and the output unit 134. As a result, it is possible for the computer 10 to execute the processes that perform the same functions as those of the reception unit 131, the reply search unit 132, the word identification unit 133, and the output unit 134. A program referred to in the other embodiments is not limited to a program to be executed by the computer 10. For example, it is possible to apply the present disclosure in the case where the other computers or servers execute a program, or a combination of these executes a program in the same manner.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
obtaining document data;
when a plurality of documents are included in the obtained document data, based on an occurrence frequency of each word included in one of the plurality of documents among the plurality of documents and an occurrence frequency of the each word in another document included in the plurality of documents, identifying a word from the each word; and
generating a question sentence regarding the identified word.

2. The storage medium according to claim 1, wherein the identifying includes:
identifying a plurality of documents having a similarity between the documents satisfying a criterion among the plurality of documents included in the obtained document data, and
selecting the one of the documents and the other of the documents from the identified plurality of documents.

3. The storage medium according to claim 2,
wherein the identifying includes identifying a word featuring each document in a plurality of documents having the similarity between the documents satisfying the criterion.

4. The storage medium according to claim 3,
wherein the generating includes generating the question sentence by using a word indicating a superordinate concept common to a word featuring the identified each document.

5. The storage medium according to claim 3, wherein the generating includes:
identifying a word regarding an operation or an attribute extracted based on a semantic network corresponding to a word featuring the each document, and
generating the question sentence by converting the operation or the attribute into an interrogative sentence.

6. The storage medium according to claim 1, wherein
the obtaining includes obtaining the document data including a plurality of documents including question contents and reply contents, and
the identifying includes identifying the word based on at least one of an occurrence frequency of the word included in the plurality of documents in the question contents and an occurrence frequency of the word in the reply contents.

7. The storage medium according to claim 1, further comprising
receiving input of an inquiry from a user,
wherein the obtaining includes extracting from a reply database the document data including the plurality of documents corresponding to a response document candidate for an inquiry from the user, and
the generating includes generating a question sentence for identifying the response document from the extracted plurality of documents.

8. The storage medium according to claim 1, further comprising:
receiving a reply from a user to the generated question sentence; and
further obtaining document data including a plurality of documents corresponding to a response document candidate for the received reply.

9. An information processing method executed by a processor included in an information processing apparatus, the information processing method comprising:
obtaining document data;
when a plurality of documents are included in the obtained document data, based on an occurrence frequency of each word included in one of the plurality of documents among the plurality of documents and an occurrence frequency of the each word in another document included in the plurality of documents, identifying a word from the each word; and
generating a question sentence regarding the identified word.

10. An information processing apparatus, comprising:
a memory; and
a processor coupled to the memory and configured to:
obtain document data,
when a plurality of documents are included in the obtained document data, based on an occurrence frequency of each word included in one of the plurality of documents among the plurality of documents and an occurrence frequency of the each word in another document included in the plurality of documents, identify a word from the each word, and
generate a question sentence regarding the identified word.

11. The information processing apparatus according to claim 10,
wherein the processor is configured to:
identify a plurality of documents having a similarity between the documents satisfying a criterion among the plurality of documents included in the obtained document data, and
select the one of the documents and the other of the documents from the identified plurality of documents.

12. The information processing apparatus according to claim 11,
wherein the processor is configured to identify a word featuring each document in a plurality of documents having the similarity between the documents satisfying the criterion.

13. The information processing apparatus according to claim 12,
wherein the processor is configured to generate the question sentence by using a word indicating a superordinate concept common to a word featuring the identified each document.

14. The storage medium according to claim 12,
wherein the processor is configured to:
identify a word regarding an operation or an attribute extracted based on a semantic network corresponding to a word featuring the each document, and
generate the question sentence by converting the operation or the attribute into an interrogative sentence.
